(19) United States
(12) Patent Application Publication
(10) Pub. No.: US 2004/0111236 A1
(43) Pub. Date: Jun. 10, 2004

(54) Method of gathering statistics of channel resource occupancy in mobile communication systems

(75) Inventors: Jin Woo Lee, Seoul (KR); Hyo Sig Jean, Suwon-si (KR)

Correspondence Address: FLESHNER & KIM, LLP, P.O. BOX 221200, CHANTILLY, VA, 20153, US

(73) Assignee: LG Electronics Inc.

(21) Appl. No.: 10/724,236

(22) Filed: Dec. 1, 2003

(30) Foreign Application Priority Data
Dec. 2, 2002 (KR) 2002-75885

(51) Int. Cl. G06F 17/18; G06F 101/14; G06F 15/00

(52) U.S. Cl. 702/179

(57) ABSTRACT

A method and apparatus are provided for gathering statistical information on channel resource occupancy in mobile communication systems. This may provide an operator with reference materials for cell planning in a region where a base station covers and materials on increasing base stations based on a handoff holding time on each base station, by analyzing wireless environment with the channel resource statistical data gathered by counting a period while a call is set up alone by a call origination and termination as a holding time and by counting a period while a soft added call is set up by a handoff request as a handoff holding time.

The present application claims priority from Korean Patent Application No. 2002-75885, filed Dec. 2, 2002, the subject matter of which is incorporated herein by reference.

### BACKGROUND OF THE INVENTION

1. Field of the Invention

Embodiments of the present invention may relate to a method of gathering statistical information on channel resource occupancy in mobile communication systems. More particularly, embodiments of the present invention may relate to gathering statistical information on channel resource occupancy at individual base stations for each call.

2. Background of Related Art

In gathering statistical information on channel resources holding times in a mobile communication system when just origination and termination of a call for a mobile terminal are achieved, the channel resource occupancy may be counted as a holding time of the originated/terminated call (i.e., an origination and termination holding time). Further, when a call is setup between another base station and the mobile terminal by a handoff request from the mobile terminal, the channel resource occupancy may be counted as a holding time of a handoff call (i.e., a handoff holding time).

Statistical information on the holding times (including origination and termination holding time and handoff holding time) may be provided to an operator.

Channel resource holding times may be used in the mobile communication systems for Erlang calculation. The channel resource may be one base station modem resource.

FIG. 1 illustrates one configuration for gathering statistical information of channel resources in mobile communications. The system may include a base station manager (BSM) 10, a base station statistics unit 20, a base station channel resource statistics database 30 and a base station call processing unit 40.

The BSM 10 may request the base station statistics unit 20 to collect statistical data (or statistical information) at prescribed time intervals or based on an operator's request, for example. The BSM 10 may provide the operator with channel resource statistical information transmitted from the base station statistics unit 20.

The base station statistics unit 20 may receive a statistical data collecting request from the BSM 10 and transmit channel resource statistical information stored in the base station channel resource statistics database 30 to the BSM 10 in response to the received statistical data collecting request. Further, the base station statistics unit 20 may clear the base station channel resource statistics database 30 on transmitting the channel resource statistics information to the BSM 10.

The base station channel resource statistics database 30 may store statistical data transmitted from the base station call processing unit 40 in the form of channel resource statistical information and output the stored channel resource statistical information based on control of the base station statistics unit 20.

The base station call processing unit 40 detects the occurrence of call and handoff requests and collects statistical data on how long a call occupies channel resource (i.e., conversation time). The base station call processing unit 40 may then transmit the collected statistical data to the base station channel resource statistics database 30 where it may be stored. The statistical data may include a holding time of an originated/terminated call and a holding time of a handoff call.

A method of gathering statistical information on channel resource occupancy in a mobile communication system having the above-described configuration will now be described with reference to FIG. 2.

A base station call processing unit 40 in a base station may separately collect holding times of an originated/terminated call (e.g., time in seconds) and a holding time of a handoff call as statistical data (or statistical information). The collected data may be transmitted to the base station channel resource statistics database 30 in order to store the collected data.

If a mobile terminal performs a call origination and termination with respect to a base station to which the mobile terminal belongs (e.g., a source base station), then a base station call processing unit 40 in the source base station detects the occurrence of the call requested from the mobile terminal (S1). The base station call processing unit 40 makes the call occupy a channel resource by allotting the channel resource to the call (i.e., a base station modem resource) (S2). A holding timer may begin for the originated/terminated call (S3).

However, when the mobile terminal moves to another region (i.e., a region covered by a target base station), then the mobile terminal transmits a handoff request to the target base station. In response to the handoff request, a base station call processing unit 40 in the target base station that received the handoff request from the mobile terminal makes the call occupy a channel resource by allotting the channel resource (S5). A handoff holding timer may begin corresponding to a handoff call setup (S6).

If the call set up through the source base station (hereafter the source call) is completed by the above operation, then the base station call processing unit 40 in the source base station may check completion of the source call (S7) and withdraw the allotted channel resource (S8) by clearing the source call.

The base station call processing unit 40 in the source base station may collect statistical data (i.e., a holding time) on how long the source call maintains an occupying state (i.e., a conversation time). The holding timer is then stopped and the base station channel resource statistics database 30 in the source base station stores the holding time (S9).

If the call setup by handoff (hereafter the handoff call) is completed, then the base station call processing unit 40 in the target base station may check whether the call has been completed (S10) and withdraw the allotted channel resource if the call was completed (S11).

The base station call processing unit 40 in the target base station may collect statistical data (i.e., the handoff holding time) on how long the handoff call maintains an occupying state (i.e., the conversation time). The handoff holding timer is then stopped and the base station channel resource statistics database 30 in the target base station stores the handoff holding time (S12).

If the BSM 10 requests the base station statistics unit 20 in the source base station or the target base station to collect statistical data at prescribed time intervals or based on an operator's request, then the corresponding base station statistics unit 20 that received the statistical data collecting request from the BSM 10 may transmit channel resource statistical information stored in the base station channel resource statistics database 30 to the BSM 10 and clear the base station channel resource statistics database 30.

The BSM 10 may provide an operator with channel resource statistical information transmitted from the base station statistics unit 20. This information may include a holding time of an originated/terminated call and a holding time of a handoff call.

The holding time of an originated/terminated call described herein may correspond to a point of time when the originated/terminated call occupies a channel resource to a point of time when the channel resource is withdrawn due to completion of the originated/terminated call. The holding time of a handoff call may correspond to a point of time when the handoff call occupies a channel resource on the target base station's receiving handoff request to a point of time when the channel resource is withdrawn due to completion of the handoff call.

As described above, one method of gathering statistical information on channel resource occupancy in a mobile communication system may involve a source base station counting a holding time of an originated/terminated call from a time of setting up a call to a time of completing the call and a target base station counting a holding time of a handoff call from a time of setting up a call to a time of completing the call. A channel resource holding time may be used in mobile communication systems for Erlang calculation.

Handoff technology may support mobility of mobile terminal users (i.e., allow the mobile terminal user to move freely) even though conversations are going on due to a call setup. Handoffs may include a soft handoff and a hard handoff. The soft handoff supports mobility of mobile terminal users without disconnection even for a moment. Soft handoff may be implemended with not just one base station but several base stations while the mobile terminal's location is changed.

In mobile communication systems, traffic channels may be set up with three base stations at the same time. A call whose traffic channel is set up with only one base station may be called a ‘single call’ and a call whose traffic channels are set up with more than two base stations may be called a ‘soft added call.’

When a call is soft added, mobility of the mobile terminal user is supported by wireless capacity and system resources seem to be used excessively in view of the system. Thus, if soft added calls occur often, then wireless capacity and system resources may be wasted.

Base stations in downtown areas may be located within short distances so that soft added status may occur often and excessive resource occupancy due to a handoff call having a bad effect on setting up newly originated/terminated call.

Thus, in order to determine whether to increase and decrease base stations, or whether problems may be solved through adjustment of cell coverages, statistical information on occupancy of channel resources allotted to base stations may be needed. However, statistical information on channel resource occupancy may not be gathered at certain base stations separately for single call and soft added calls.

### SUMMARY OF THE INVENTION

An object of the invention is to solve at least the above problems and/or disadvantages and to provide at least the advantages described hereinafter.

Embodiments of the present invention may provide a method of gathering statistical information on channel resource occupancy at individual base stations for each call in a mobile communication system.

Embodiments of the present invention may make it possible to determine whether to increase and decrease base stations, or whether problems may be solved through adjustment of cell coverage, for example, based on gathered materials such as gathering statistical information on channel resource occupancy for single calls and soft added calls at individual base stations.

Embodiments of the present invention may provide an operator with reference materials for cell planning of regions where a base station covers and materials on increasing base stations based on handoff holding time data at individual base stations.

Embodiments of the present invention may provide a method of gathering statistical information on channel resource occupancy in a mobile communication system. This may include providing a holding time as statistical information on a channel resource occupancy by calculating the holding time separately for single calls and soft added calls according to channel resource occupancy at individual base stations in the mobile communication system.

Determining the holding time as statistical information on the channel resource occupancy may include: calculating a holding time by counting a period while an originated/terminated call is set up; and calculating a handoff holding time by counting a period when soft added calls are set up.

Calculating the holding time may be achieved by counting the holding time from a point of time when a channel resource is occupied due to a call origination/termination to a point of time when the channel resource is withdrawn due to completion of the originated/terminated call.

Calculating the holding time may also be achieved by counting the holding time from a point of time when a channel resource is occupied due to receipt of a call origination/termination request message to a point of time when a soft add notification message is received from other base stations after the call setup in response to the call origination/termination request. A holding time may be counted from a point of time when soft drop notification messages are received from other base stations to a point of time when a channel resource is withdrawn due to completion of the soft added call.

Calculating the handoff holding time may be achieved by counting a handoff holding time from a point of time when a source base station receives soft add notification messages from other base stations to a point of time when a channel resource is withdrawn due to completion of the soft added call.

Calculating the handoff holding time may also be achieved by counting a handoff holding time from a point of time when a channel resource is occupied due to a target base station's receipt of a handoff request from a mobile terminal to a point of time when the target base station receives soft drop notification messages from other base stations.

Calculating the handoff holding time may also be achieved by counting a handoff holding time from a point of time when a channel resource is occupied due to a neighbor base station's receipt of the handoff request from a mobile terminal to a point of time when the neighboring base station transmits a soft drop notification message and the channel resource is withdrawn.

Embodiments of the present invention may involve calculating a holding time by counting only a period while an originated/terminated call is set up and calculating a handoff holding time by counting only a period while soft added calls are set up due to a handoff.

Calculating the holding time may include setting up a single call by a source base station's detecting the originated/terminated call and allotting a channel resource. A first holding timer may begin. When the source base station receives soft add notification messages from other base stations, the method may include calculating a first holding time by stopping the first holding timer. When a new single call for a target base station is set up and the other base stations are dropped, the method may include beginning to operate a second holding timer. When the single call for the target base station is completed, the method may include calculating a second holding time by withdrawing the channel resources and stopping the second holding timer.

Calculating the handoff holding time may include setting up a soft added call by a target base station's detecting a handoff request from a mobile terminal, transmitting a soft add notification message and allotting a channel resource, and beginning to operate a second handoff holding timer. When the source base station receives the soft add notification message from other base stations, the method may include beginning to operate a first handoff holding timer. When a soft added call for the source base station is completed, the method may include transmitting a soft drop notification message and calculating a first handoff holding time by withdrawing the channel resource and by stopping the first handoff holding timer at the same time. When the target base station receives the soft drop notification message from other base stations, the method may include calculating a second handoff holding time by stopping the second handoff holding timer.

Additional advantages, objects, features and embodiments of the present invention will be set forth in part in the description that follows and in part will become apparent to those having ordinary skill in the art upon examination of the following or may be learned from practice of the invention.

### BRIEF DESCRIPTION OF THE DRAWINGS

The following represents brief descriptions of the drawings in which like reference numerals refer to like elements and wherein:

FIG. 1 is a block diagram of a configuration for gathering statistical information of channel resource occupancy in a mobile communication system according to one example arrangement;

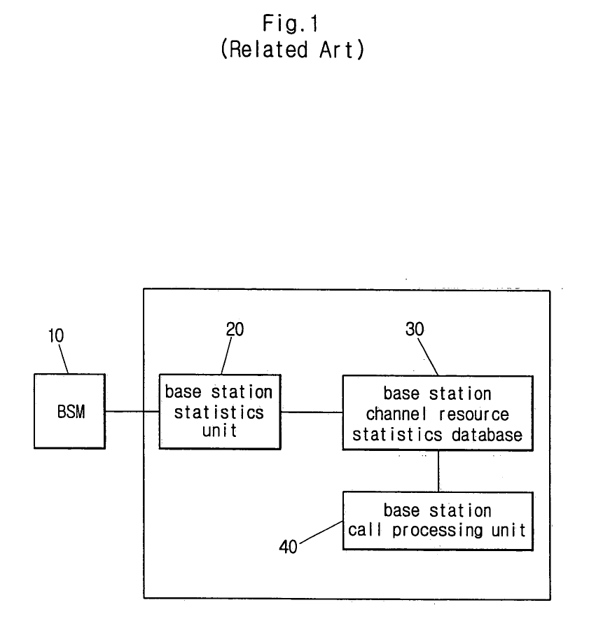

FIG. 2 is a flowchart of a method of gathering statistical information on channel resource occupancy in a mobile communication system according to one example arrangement;

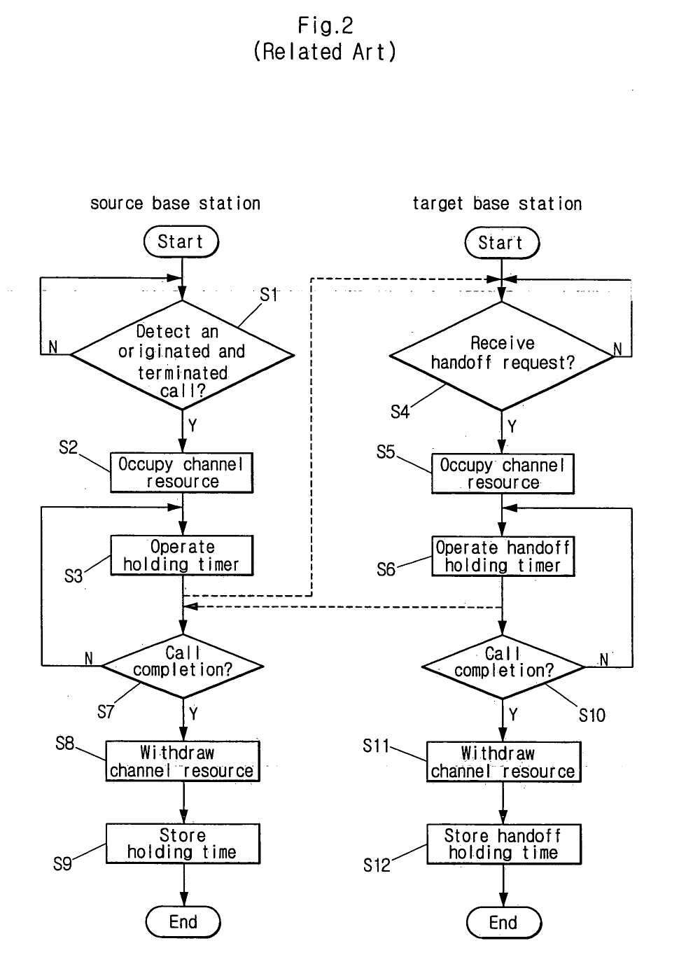

FIG. 3 illustrates a holding time of a single call in a mobile communication system according to an example embodiment of the present invention;

FIG. 4 illustrates a holding time of a soft added call in a mobile communication system according to an example embodiment of the present invention; and

FIG. 5 is a flowchart of a method of gathering statistical information on channel resource occupancy in a mobile communication system according to an example embodiment of the present invention.

### DETAILED DESCRIPTION OF PREFERRED EMBODIMENTS

Embodiments of the present invention may gather statistical information of channel resource occupancy in a mobile communication system in order to analyze a wireless environment. This may involve a base station call processing unit separately gathering statistical information on channel resource occupancy for a single call and a soft added call at each base station. The statistical information on the channel resource occupancy may be stored in a base station channel resource statistics database. A base station statistics unit may interpret the statistical information on the channel resource occupancy stored in the base station channel resource statistics database. Holding times may be counted separately for a single call and a soft added call according to channel resource occupancy at each base station when the call is soft added, by using the holding time as materials of the handoff holding time at each of the base stations.

A channel resource holding time in a mobile communication system may be classified into a holding time of an originated/terminated call (hereafter an origination and termination holding time) and a holding time of a handoff call when a new call is setup due to a handoff (hereafter a handoff holding time).

The origination and termination holding time may correspond to a period when an originated/terminated call is setup. This may be achieved using a holding timer only when the originated/terminated call is setup. The origination and termination holding time may include a holding time when the originated/terminated call is setup and a holding time when a handoff is achieved.

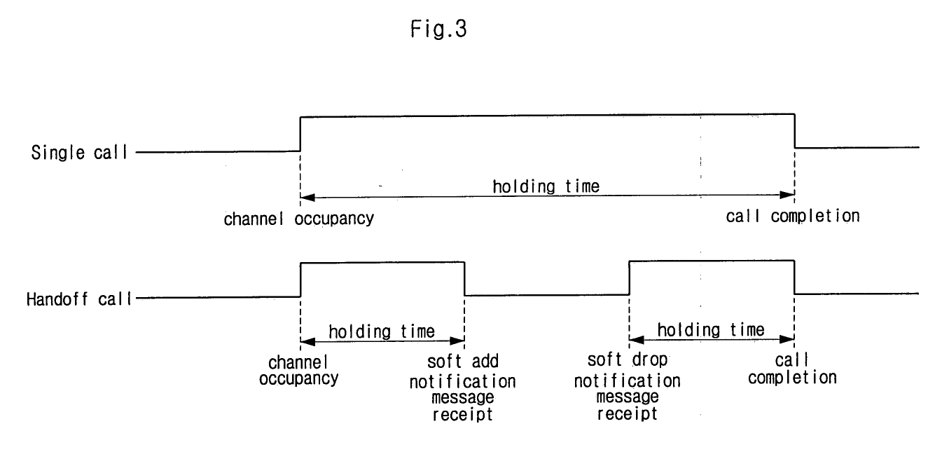

The origination and termination holding time may be counted from a point of time when the originated/terminated call occupies a channel resource by trying a call through a base station to a point of time when the channel resource is withdrawn due to completion of the call as shown in FIG. 3.

The origination and termination holding time of a base station (i.e., the source base station) before a handoff may be counted from a point of time when the originated/terminated call occupies a channel resource by the source base station's receiving a message from the mobile terminal requesting call origination and termination to a point of time when the call is soft added when the source base station receives the soft add notification message from another base station (i.e., a target base station). Further, the origination and termination holding time of the target base station after the handoff may be counted from a point of time when the originated and terminated call is set up by the target base station's receiving the soft drop notification message from the other base station due to drop of the other soft added base stations for the originated/terminated call, to a point of time when the channel resource is withdrawn due to completion of the call.

The soft add notification message described herein may be a message notifying that a call is soft added. On the other hand, the soft drop notification message may be a message notifying that soft added base stations are soft dropped.

The handoff holding time may be a period when soft added calls are set up that may be counted by operating a handoff holding timer only while the soft added calls are set up. Calculation of the handoff holding time may be performed separately for the source base station, the target base station and the soft added neighbor base station.

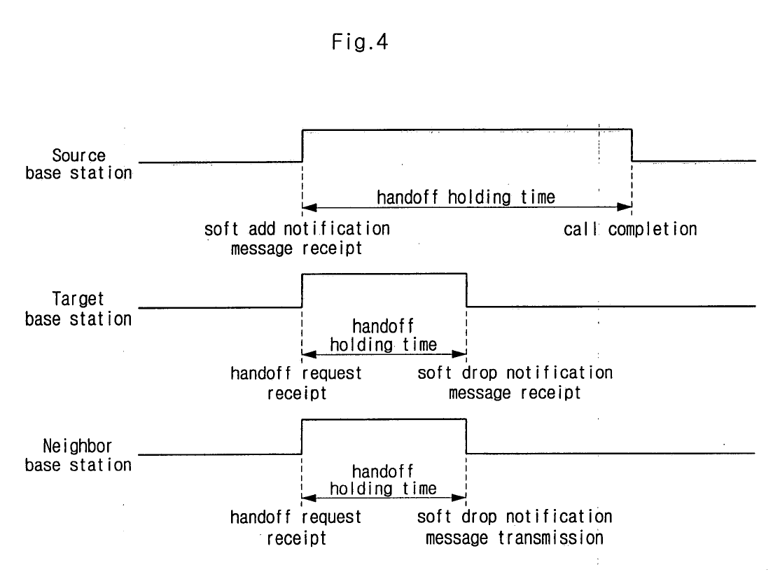

FIG. 4 illustrates how a handoff holding time may be counted according to an example embodiment of the present invention. Other embodiments are within the scope of the present invention. First, a handoff holding time of the source base station may be counted, as shown in FIG. 4, from a point of time when soft added calls are set up (such as when a soft add notification message is received from the other base stations) by achieving soft added status through soft handoff to the other base stations to a point of time when the channel resource is withdrawn due to completion of the call.

Second, a handoff holding time of the target base station may be counted, as shown in FIG. 4, from a point of time when soft added calls are set up by the target base station's occupying a channel resource due to receipt of a handoff request from a mobile terminal, to a point of time when the call is independently set up again by receiving a soft drop notification message from the other base stations.

Third, a handoff holding time of the soft added neighbor base station may be counted, as shown in FIG. 4, from a point of time when soft added calls are set up by the neighbor base station's occupying channel resource due to receipt of a handoff request from a mobile terminal, to a point of time when the occupied channel resource is withdrawn on transmitting the soft drop notification message to the target base station.

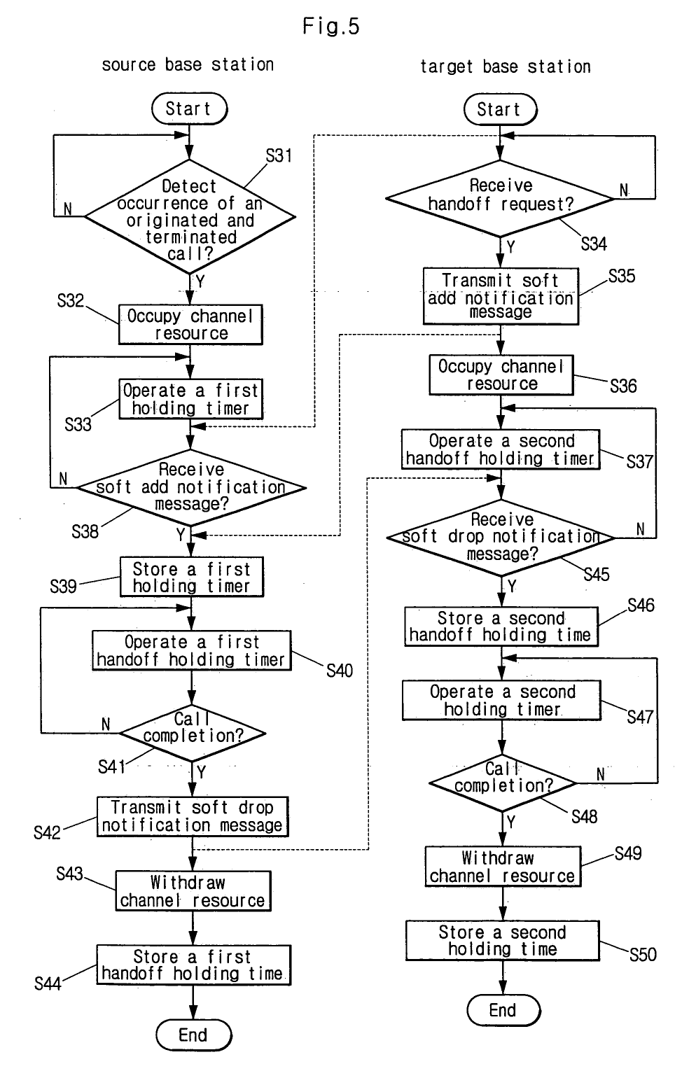

A method of gathering statistical information on channel resources in a mobile communication system according to an example embodiment of the present invention will now be described with respect to FIG. 5. That is, FIG. 5 is a flowchart showing operations of an example embodiment of the present invention. Other operations, orders of operations and embodiments are within the scope of the present invention.

If a mobile terminal transmits a message requesting call origination/termination to a base station to which the mobile terminal belongs (i.e., a source base station), then a base station call processing unit in the source base station may detect an occurrence of an originated/terminated call from the mobile terminal (S31). The base station call processing unit may make the call occupy a corresponding channel resource by allotting the channel resource (S32). A first holding time of an originated/terminated call may be counted by operating a first holding timer for the originated/terminated call (S33).

When the mobile terminal moves to another region (i.e., a region where a target base station covers), then the mobile terminal may transmit a handoff request to the target base station. A base station call processing unit in the target base station receives the handoff request from the mobile terminal (S34) and transmits a soft add notification message to the source base station notifying that a soft added call is set up through the corresponding channel (S35).

The base station call processing unit in the target base station makes the call occupy the channel resource by allotting the channel resource (S36) A second handoff holding time is started by a second handoff holding timer for call set up due to a handoff (S37).

On the other hand, the base station call processing unit in the source base station may check whether a soft add notification message is received from the target base station (S38). If so, then a first base station channel resource statistics database stores the first holding time of the originated/terminated call as statistical data therein when the soft add notification message is received by stopping the first holding timer (S39).

The base station call processing unit in the source base station starts to count a first handoff holding time when the soft added call is set up by operating a first handoff holding timer for the soft added source call due to a handoff (S40).

The base station call processing unit 40 in the source base station (or a base station call processing unit in another neighbor base station (not shown)) may check whether the set up source call is completed (S41). The base station call processing unit 40 in the source base station may transmit a soft drop notification message to the target base station (S42) notifying that the source base station is dropped from the soft added status. At the same time, the base station call processing unit 40 in the source base station may clear the soft added call and withdraw the allotted channel resource (S43).

The base station call processing unit in the source base station (40) (or a base station call processing unit in another neighbor base station) may gather statistical information (i.e., the first handoff holding time) about how long the call maintains soft added status by stopping the first handoff holding timer and making the first base station channel resource statistics database store the statistical data therein (S44).

On the other hand, the base station call processing unit in the target base station may continuously operate the second handoff holding timer since soft added calls have been set up and check whether a soft drop notification message transmitted from the source base station exists or not (S45). When the soft drop notification message is received, the base station call processing unit in the target base station may gather statistical information (i.e., the second handoff holding time) about how long the call maintains the soft added status by stopping the second handoff holding timer and making a second base station channel resource statistics database store the statistical data therein (S46).

The base station call processing unit in the target base station may start to count a second holding time of an originated/terminated call by beginning to operate a second holding timer for the originated/terminated call when all the other soft added base stations are dropped and the soft added call becomes a single call set up by the target base station (S47).

The base station call processing unit in the target base station may check whether the single call set up by the target base station is completed or not (S48). The base station call processing unit may withdraw the allotted channel resource when the single call is completed (S49).

The base station call processing unit in the target base station may gather the second holding time of the originated/terminated call by stopping the second holding timer and making the second base station channel resource statistics database store the second holding time (S50).

If the BSM requests the base station statistics units in the source base station and the target base station to gather statistical information at prescribed time intervals or based on an operator's request, each of the base station's statistics unit may transmit channel resource statistics information stored in each individual base station channel resource statistics database in response to a statistical data collecting request from the BSM and simultaneously clear each base station channel resource statistics database.

The BSM may provide the operator with channel resource statistical information transmitted from each of the base station's statistics units. This may include the source base station's holding time of an originated/terminated call, the source base station's handoff holding time, the target base station's holding time of an originated/terminated call, the target base station's handoff holding time and neighbor base station's handoff holding time.

The holding time of the originated/terminated call as described herein may be only a period when a call is set up alone by call origination/termination. Further, a handoff holding time as described herein may be only a period when a soft added call is set up by a handoff request of a mobile terminal.

Embodiments of the present invention may provide the operator with reference materials for cell planning in a region covered by a base station as well as provide materials on increasing base stations based on handoff holding time materials on each base station, by analyzing wireless environment with channel resource statistical information gathered by counting a holding time separately for a single call and a soft added call according to each base station's channel resource occupancy.

The foregoing embodiments and advantages are merely exemplary and are not to be construed as limiting the present invention. The present teaching can be readily applied to other types of methods. The description of the present invention is intended to be illustrative, and not to limit the scope of the claims. Many alternatives, modifications and variations will be apparent to those skilled in the art.

What is claimed is:

1. A method of gathering statistical information comprising:
calculating a holding time for a single call; and
calculating a holding time of a soft added call.

2. The method of claim 1, wherein the single call relates to a call of a mobile terminal with respect to one base station.

3. The method of claim 1, wherein the soft added call relates to a call of a mobile terminal with respect to more than one base station.

4. The method of claim 1, further comprising determining a holding time based on the calculated holding time of the single call and the calculated holding time of the soft added call.

5. The method of claim 4, wherein calculating the holding time of the single call comprises counting a period when an originated/terminated call is set up.

6. The method of claim 5, wherein calculating the holding time comprises counting the holding time from a point of time when a channel resource is occupied due to a call origination/termination to a base station to a point of time when the channel resource is withdrawn.

7. The method of claim 5, wherein calculating the holding time comprises counting the holding time from a point of time when a channel resource is occupied due to receipt of a call origination/termination request message to a point of time when a soft add notification message is received from another base station after call setup in response to the call origination/termination request, and counting the holding time from a point of time when the soft drop notification message is received from the another base station to a point of time when the channel resource is withdrawn due to completion of the soft added call.

8. The method of claim 1, wherein calculating the holding time of the soft added call includes calculating a handoff holding time by counting a period when soft added calls are set up.

9. The method of claim 8, wherein calculating the handoff holding time comprises counting the handoff holding time from a point of time when a source base station receives a soft add notification message from another base station to a point of time when the channel resource is withdrawn.

10. The method of claim 8, wherein calculating the handoff holding time comprises counting the handoff holding time from a point of time when the channel resource is occupied due to a target base station's receipt of a handoff request from a mobile terminal to a point of time when the target base station receives a soft drop notification message from another base station.

11. The method of claim 8, wherein calculating the handoff holding time comprises counting the handoff holding time from a point of time when the channel resource is occupied due to a neighboring base station's receipt of a handoff request from a mobile terminal to a point of time when the neighboring base station transmits a soft drop notification message and the channel resource is withdrawn.

12. A method of gathering statistical information regarding a mobile communication system, comprising:
calculating a holding time by counting a period of an originated/terminated call; and
calculating a handoff holding time by counting a period when soft added calls are set up due to a handoff.

13. The method of claim 12, wherein calculating the holding time comprises:
setting up a single call by a source base station's detecting the originated/terminated call and allotting a channel resource; and
starting a first holding timer.

14. The method of claim 13, wherein when the source base station receives a soft added notification message from another base station, calculating the holding time further comprises calculating a first holding time based on said first holding timer.

15. The method of claim 14, wherein when a new single call for a target base station is set up and the other base stations are dropped, calculating the holding time further comprises starting a second holding timer.

16. The method of claim 15, wherein when the single call for the target base station is completed, calculating the holding time further comprises withdrawing the channel resource and calculating a second holding time by stopping said second holding timer.

17. The method of claim 12, wherein calculating the handoff holding time comprises:
setting up a soft added call by a target base station's detecting a handoff request from a mobile terminal, transmitting a soft add notification message, allotting a channel resource, and beginning a first handoff holding timer.

18. The method of claim 17, wherein when a source base station receives the soft add notification message from another base station, calculating the handoff holding time further comprises beginning a second handoff holding timer.

19. The method of claim 18, wherein when a soft added call for the source base station is completed, calculating the handoff holding time further comprises transmitting a soft drop notification message, withdrawing the channel resource and calculating a first handoff holding time by stopping said first handoff holding timer.

20. The method of claim 19, wherein when the target base station receives the soft drop notification message from another base station, calculating the handoff holding time further comprises calculating a second handoff holding time by stopping the second handoff holding timer.

21. A method comprising:
determining a channel resource occupancy for a single call; and
determining a channel resource occupancy for a soft added call.

22. The method of claim 21, wherein the single call relates to a call of a mobile terminal with respect to one base station.

23. The method of claim 21, wherein the soft added call relates to a call of a mobile terminal with respect to more than one base station.

24. The method of claim 21, wherein the channel resource occupancy for the single call comprises a holding time.

25. The method of claim 24, wherein determining the channel resource occupancy for the single call comprises calculating the holding time by counting a period when an originated/terminated call is set up.

26. The method of claim 24, wherein calculating the holding time includes counting the holding time from a point of time when a channel resource is occupied due to a call origination/termination to a base station to a point of time when the channel resource is withdrawn.

27. The method of claim 24, wherein calculating the holding time includes counting the holding time from a point of time when a channel resource is occupied due to receipt of a call origination/termination request message to a point of time when a soft add notification message is received from an other base station after call setup in response to the call origination/termination request, and counting the holding time from a point of time when the soft drop notification message is received from the another base station to a point of time when the channel resource is withdrawn due to completion of the soft added call.

28. The method of claim 21, wherein the channel resource occupancy for the soft added cell comprises a handoff holding time.

29. The method of claim 28, wherein determining the channel resource occupancy for the soft added call comprises calculating a handoff holding time by counting a period when soft added calls are set up.

30. The method of claim 29, wherein calculating the handoff holding time includes counting the handoff holding time from a point of time when a source base station receives a soft add notification message from another base stations to a point of time when the channel resource is withdrawn.

31. The method of claim 29, wherein calculating the handoff holding time includes counting the handoff holding time from a point of time when the channel resource is occupied due to a target base station's receipt of a handoff request from a mobile terminal to a point of time when the target base station receives a soft drop notification messages from another base station.

32. The method of claim 29, wherein calculating the handoff holding time includes counting the handoff holding time from a point of time when the channel resource is occupied due to neighbor base station's receipt of a handoff request from a mobile terminal to a point of time when the neighbor base station transmits a soft drop notification message and the channel resource is withdrawn.
